(19) United States
(12) Patent Application Publication
(10) Pub. No.: US 2026/0211350 A1
(43) Pub. Date: Jul. 23, 2026

(54) TONER, PROCESS CARTRIDGE, AND IMAGE FORMING APPARATUS

(71) Applicant: CANON KABUSHIKI KAISHA, Tokyo (JP)

(72) Inventors: TAKUHO SATO, Shizuoka (JP); KENTA KAMIKURA, Kanagawa (JP); KAZUYUKI SATO, Kanagawa (JP); KENTA KATAYAMA, Shizuoka (JP); KAZUNARI OHIRA, Shizuoka (JP)

(21) Appl. No.: 19/445,352

(22) Filed: Jan. 9, 2026

(30) Foreign Application Priority Data
Jan. 17, 2025 (JP) 2025-006520
Dec. 11, 2025 (JP) 2025-245144

(51) Int. Cl. G03G 9/087; G03G 21/18

(52) U.S. Cl. CPC G03G 9/08782; G03G 9/08708; G03G 21/1814

(57) ABSTRACT

A toner includes a toner particle containing a binder resin, an olefin unit-containing polystyrene resin B, and an ester wax A. The olefin unit-containing polystyrene resin B is a copolymer having an olefin unit and a styrene unit. The ester wax A is an ester compound having a structure represented by formula (A).

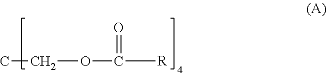

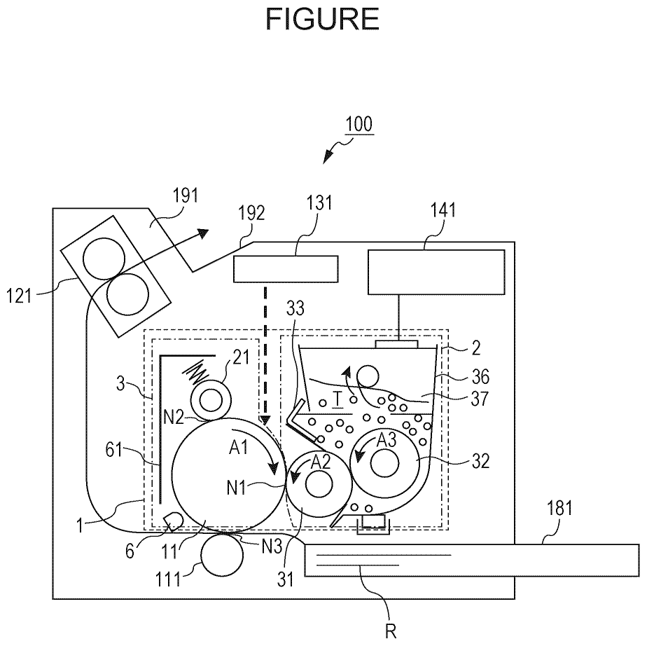

In formula (A), each R independently represents an n-alkyl group. The ester compound includes, as the n-alkyl group, n-heneicosyl group, n-nonadecyl group, and n-heptadecyl group. A content proportion of n-heneicosyl group is 50.0% by mass or greater and 80.0% by mass or less, a content proportion of n-nonadecyl group is 5.0% by mass or greater and 15.0% by mass or less, and a content proportion of n-heptadecyl group is 15.0% by mass or greater and 30.0% by mass or less, with respect to a total mass of groups which is included as the n-alkyl group.

### BACKGROUND

### Field of the Technology

The present disclosure relates to a toner, a process cartridge, and an image forming apparatus used in a recording method performed by an electrophotographic method, an electrostatic recording method, and a toner jet type recording method.

### Description of the Related Art

In recent years, an electrophotographic forming apparatus is required to perform printing at a higher speed, have improved environmental adaptability so that printing can be performed in various environments, and have a small-sized cartridge. In order to realize this, further improvement is required in the toner. For example, the toner is required to have improved fixability to contribute to an increase in speed of an electrophotographic apparatus. When the low-temperature fixability can be improved, the process speed for sticking the toner to paper can be increased, which results in an increase in speed. Further, when the temperature range in which the toner can be fixed can be expanded, images can be stably output even in a case where the images are printed at a high speed. Accordingly, an important object is to expand the temperature range in which the toner can be fixed and improve the low-temperature fixability in the electrophotographic forming apparatus.

WO2023/127815 discloses a toner which has excellent low-temperature fixability and to which a block copolymer having a conjugated diene structure is added for the purpose of suppressing the toner from being jetted out after standing at a high temperature.

Further, a known method of using a plurality of types of waxes with different melting points in combination in order to ensure release properties in a wide fixing temperature range is effective as a method of expanding the temperature range in which the toner can be fixed. WO2020/075660 discloses a toner that can improve the low-temperature fixability and the heat-resistant storage stability by using an ester wax generated by an esterification reaction between pentaerythritol and a plurality of types of monocarboxylic acids.

### SUMMARY

However, it has been found that since the wax contained in the toner of WO2023/127815 is formed of only a single component, the temperature range in which the toner can be fixed is narrow, and the toner has a disadvantage in terms of outputting images when a high-speed machine is used.

Further, it has also been found that the toner of WO2020/075660 has improved low-temperature fixability, but has a disadvantage in terms of the durability in a high-temperature environment.

Therefore, there has been a demand for further substances, devices, and improvement methods for achieving both the durability and the fixability in a high-temperature environment.

The present disclosure provides a toner capable of achieving both the durability and a wide fixing temperature range even in a high-temperature environment.

According to an aspect of the present disclosure, there is provided a toner including: a toner particle that contains a binder resin, an olefin unit-containing polystyrene resin B, and an ester wax A, in which the olefin unit-containing polystyrene resin B is a copolymer having an olefin unit and a styrene unit, the ester wax A is an ester compound having a structure represented by formula (A),

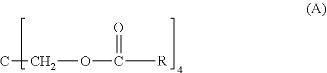

in formula (A), each R independently represents an n-alkyl group,
the ester compound includes, as the n-alkyl group, n-heneicosyl group, n-nonadecyl group, and n-heptadecyl group, a content proportion of n-heneicosyl group is 50.0% by mass or greater and 80.0% by mass or less with respect to a total mass of groups which is included as the n-alkyl group, a content proportion of n-nonadecyl group is 5.0% by mass or greater and 15.0% by mass or less with respect to the total mass of groups which is included as the n-alkyl group, and a content proportion of n-heptadecyl group is 15.0% by mass or greater and 30.0% by mass or less with respect to the total mass of groups which is included as the n-alkyl group.

According to another aspect of the present disclosure, there is provided a process cartridge that is detachably attachable to an image forming apparatus, the process cartridge including: a toner; and a toner container that accommodates the toner, in which the toner comprises a toner particle containing a binder resin, an olefin unit-containing polystyrene resin B, and an ester wax A, in which the olefin unit-containing polystyrene resin B is a copolymer having an olefin unit and a styrene unit, the ester wax A is an ester compound having a structure represented by formula (A),

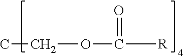

in formula (A), each R independently represents an n-alkyl group,
the ester compound includes, as the n-alkyl group, n-heneicosyl group, n-nonadecyl group, and n-heptadecyl group, a content proportion of n-heneicosyl group is 50.0% by mass or greater and 80.0% by mass or less with respect to a total mass of groups which is included as the n-alkyl group, a content proportion of n-nonadecyl group is 5.0% by mass or greater and 15.0% by mass or less with respect to the total mass of groups which is included as the n-alkyl group, and a content proportion of n-heptadecyl group is 15.0% by mass or greater and 30.0% by mass or less with respect to the total mass of groups which is included as the n-alkyl group.

Further, according to still another aspect of the present disclosure, there is provided an image forming apparatus including: a toner; a toner bearing member that bears the toner; an electrostatic latent image bearing member; a charging unit configured to cause a charging member to charge a surface of the electrostatic latent image bearing member; an electrostatic latent image forming unit configured to form an electrostatic latent image on the charged electrostatic latent image bearing member; a developing unit configured to develop the electrostatic latent image using the toner to form a toner image on the electrostatic latent image bearing member; a transfer unit configured to transfer the toner image to a recording medium; and a fixing unit configured to fix the toner image transferred onto the recording medium to the recording medium, in which the toner comprises a toner particle containing a binder resin, an olefin unit-containing polystyrene resin B, and an ester wax A, the olefin unit-containing polystyrene resin B is a copolymer having an olefin unit and a styrene unit, the ester wax A is an ester compound having a structure represented by formula (A),

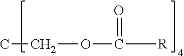

in formula (A), each R independently represents an n-alkyl group,
the ester compound includes, as the n-alkyl group, n-heneicosyl group, n-nonadecyl group, and n-heptadecyl group, a content proportion of n-heneicosyl group is 50.0% by mass or greater and 80.0% by mass or less with respect to a total mass of groups which is included as the n-alkyl group, a content proportion of n-nonadecyl group is 5.0% by mass or greater and 15.0% by mass or less with respect to the total mass of groups which is included as the n-alkyl group, and a content proportion of n-heptadecyl group is 15.0% by mass or greater and 30.0% by mass or less with respect to the total mass of groups which is included as the n-alkyl group.

Features of the present disclosure will become apparent from the following description of embodiments with reference to the attached drawing. The following description of embodiments is described by way of example.

### BRIEF DESCRIPTION OF THE DRAWING

FIGURE is a schematic view showing an image forming apparatus.

### DESCRIPTION OF THE EMBODIMENTS

Hereinafter, the present disclosure will be described in detail based on embodiments, but the present disclosure is not limited thereto. Further, the description of a numerical range of “XX or greater and YY or less” or “XX to YY” denotes a numerical range including the endpoints as the lower limit and the upper limit unless otherwise specified. In a case where numerical ranges are described in a stepwise manner, the upper limits and the lower limits of each of the numerical ranges can be used in any combination. Further, in the present disclosure, for example, the description of “at least one selected from the group consisting of XX, YY, and ZZ” denotes any one of XX, YY, ZZ, a combination of XX and YY, a combination of XX and ZZ, a combination of YY and ZZ, or a combination of XX, YY, and ZZ. Further, when XX is the group, a plurality of XXs may be selected, and the same applies to YY and ZZ. In addition, the term “monomer unit” denotes a form after a reaction of a monomer substance in a polymer.

### Features of Present Disclosure

A toner of the present disclosure is a toner comprising a toner particle that contains a binder resin, an olefin unit-containing polystyrene resin B, and an ester wax A, in which the olefin unit-containing polystyrene resin B is a copolymer having an olefin unit and a styrene unit, the ester wax A is an ester compound having a structure represented by formula (A),

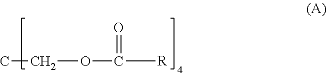

in formula (A), each R independently represents an n-alkyl group,
the ester compound includes, as the n-alkyl group, n-heneicosyl group, n-nonadecyl group, and n-heptadecyl group, a content proportion of n-heneicosyl group is 50.0% by mass or greater and 80.0% by mass or less with respect to a total mass of groups which is included as the n-alkyl group, a content proportion of n-nonadecyl group is 5.0% by mass or greater and 15.0% by mass or less with respect to the total mass of groups which is included as the n-alkyl group, and a content proportion of n-heptadecyl group is 15.0% by mass or greater and 30.0% by mass or less with respect to the total mass of groups which is included as the n-alkyl group.

The reason both durability and a wide fixing temperature range can be achieved even in a high-temperature environment when the toner of the present disclosure is used is not clear, but the present inventors speculate as follows.

A toner containing an ester wax generated by using a plurality of kinds of monocarboxylic acids as raw materials can be fixed in a wide temperature range as described above. When different components are mixed, a phenomenon known as melting point depression, in which the lattice energy of the crystal structure of each component is weakened and thus the components are likely to be melted, usually occurs. The melting point is decreased due to the influence of the melting point depression even in a state where a plurality of kinds of waxes are mixed, and as a result, a phenomenon in which the components are likely to be melted in a high-temperature environment occurs. Therefore, some of the waxes are melted in a high-temperature environment, and accordingly, the toner is locally softened. For this reason, it is assumed that when images are output in a high-speed print mode in a high-temperature environment, since the softened part of the toner serves as a starting point to be deformed as the part is rubbed against other members such as a developing roller, the adhesive force to a developing member is increased, which results in adverse effects in an image, including development stripe.

The olefin unit-containing polystyrene resin used in the present disclosure has an isoprene moiety that has a high structural affinity with the ester wax and exhibits a high restorative force against external stimuli. Therefore, the olefin unit-containing polystyrene resin can be present in the vicinity of the ester wax, and thus a stress can be exhibited due to the restorative force against deformation caused by melting of the wax. Further, π-π stacking occurring due to the effect of the aromatic ring contained in the styrene unit causes the olefin unit-containing polystyrene resins to accumulate and form pseudo-crosslinking. For this reason, the restorative force is further increased so that the deformation can be more effectively suppressed, and as a result, the toner can be suppressed from being deformed or can be restored from deformation. Therefore, it is considered that such a toner contributes to suppression of adverse effects in an image, including development stripe.

### Constituent Materials and Physical Properties of Toner According to Present Disclosure

Next, the materials that can be used in the toner of the present disclosure will be described in detail.

### Ester Wax A

The ester wax A of the present disclosure is an ester compound having the following structure.

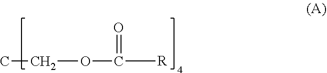

In formula (A), each R independently represents an n-alkyl group.

The ester compound includes, as the n-alkyl group, n-heneicosyl group, n-nonadecyl group, and n-heptadecyl group. Among these three kinds of alkyl groups, the amount of n-heneicosyl group is the largest, and the alkyl group contains n-heptadecyl group to cover lower temperature fixing ranges, and contains n-nonadecyl group to thoroughly cover the temperature range therebetween, particularly a low-temperature range in order to ensure the fixability. Further, the ester compound includes, as the n-alkyl group, the above-described three kinds of alkyl groups, the toner can be stably fixed in a wide temperature range.

The content proportion of the alkyl groups included in the ester compound as the n-alkyl group is required to be controlled such that the content proportion of n-heneicosyl group is 50.0% by mass or greater and 80.0% by mass or less with respect to the total mass of groups which is included as the n-alkyl group, the content proportion of n-nonadecyl group is 5.0% by mass or greater and 15.0% by mass or less with respect to the total mass of groups which is included as the n-alkyl group, and the content proportion of n-heptadecyl group is 15.0% by mass or greater and 30.0% by mass or less with respect to the total mass of groups which is included as the n-alkyl group. Further, the content proportion of n-heneicosyl group can be 60.0% by mass or greater and 70.0% by mass or less with respect to the total mass of groups which is included as the n-alkyl group, the content proportion of n-nonadecyl group can be 7.5% by mass or greater and 15.0% by mass or less with respect to the total mass of groups which is included as the n-alkyl group, and the content proportion of n-heptadecyl group can be 20.0% by mass or greater and 30.0% by mass or less with respect to the total mass of groups which is included as the n-alkyl group.

Further, the ester compound can further include, as the n-alkyl group, n-pentadecyl group. When the ester compound includes, as the n-alkyl group, n-pentadecyl group, image mottle is satisfactorily suppressed. The mottle is an adverse effect in an image, in which unevenness on the surface of paper changes the manner heat is applied to the toner, which results in uneven density. One of the causes of such an adverse effect in an image is that the toner placed in recesses of paper is melted in a state where the toner is not evenly pressurized by a fixing member such as a fixing roller, that is, under uneven pressure, and thus the wax is not sufficiently melted, which changes the manner the toner is melted and spreads. Since n-pentadecyl group has a low molecular weight, n-pentadecyl group has a low melting point and thus is easily melted, but n-pentadecyl group easily wet-spreads on the toner surface due to having low viscosity, and therefore, uniform toner dissolution is promoted when the toner is pressurized by a fixing roller. In addition, since the toner is restored from deformation due to the effect of the olefin unit, the shape unevenness is suppressed, the uneven pressure is unlikely to occur, and thus the mottle is satisfactorily suppressed from occurring. The combination of the above-described two effects satisfactorily suppresses the mottle from occurring.

From the viewpoint of sufficiently exhibiting the effects of the present disclosure, the content of n-pentadecyl group in the ester compound can be 0.1% by mass or greater and 5.0% by mass or less with respect to the total mass of groups which is included as the n-alkyl group.

The ester wax A can be produced by a known method. Examples of the method of producing such an ester wax include a method of preparing an ester wax by carrying out a condensation reaction between pentaerythritol and each carboxylic acid such as behenic acid, arachidic acid, stearic acid, or palmitic acid. Among the above-described alkyl groups included in the ester compound as the n-alkyl group, n-heneicosyl group is derived from behenic acid, n-nonadecyl group is derived from arachidic acid, n-heptadecyl group is derived from stearic acid, and n-pentadecyl group is derived from palmitic acid. N-heneicosyl group is an n-alkyl group with 21 carbon atoms, n-nonadecyl group is an n-alkyl group with 19 carbon atoms, n-heptadecyl group is an n-alkyl group with 17 carbon atoms, and n-pentadecyl group is an n-alkyl group with 15 carbon atoms.

### Other Waxes

In addition to the above-described ester wax A, other waxes may be added to the toner of the present disclosure for the purpose of imparting releasability.

Examples of the other waxes include petroleum-based hydrocarbon waxes such as paraffin wax, microcrystalline wax, and petrolatum and derivatives thereof, montan wax and derivatives thereof, hydrocarbon wax produced by the Fischer-Tropsch method and derivatives thereof,
monofunctional ester waxes typified by esters of monohydric alcohol and aliphatic carboxylic acid, such as behenyl behenate, stearyl stearate, and palmityl palmitate, or esters of monovalent carboxylic acid and aliphatic alcohol,
bifunctional ester waxes typified by esters of dihydric alcohol and aliphatic carboxylic acid, such as ethylene glycol and propylene glycol, or esters of divalent carboxylic acid and aliphatic alcohol,
trifunctional esters typified by esters of trivalent alcohol and aliphatic carboxylic acid, such as glycerin tribehenate, or esters of trivalent carboxylic acid and aliphatic alcohol,
hexafunctional ester waxes typified by esters of hexahydric alcohol and aliphatic carboxylic acid, such as dipentaerythritol hexastearate and dipentaerythritol hexapalmitate, or esters of hexavalent carboxylic acid and aliphatic alcohol,
ester waxes typified by esters of polyhydric alcohol and aliphatic carboxylic acid, such as polyglycerin behenate, or esters of polyvalent carboxylic acid and aliphatic alcohol, and
ester waxes typified by natural ester waxes such as carnauba wax and rice wax, polyolefin-based hydrocarbon waxes such as polyethylene and polypropylene and derivatives thereof, and natural waxes such as carnauba wax and candelilla wax and derivatives thereof. The derivatives include oxides, block copolymers with vinyl monomers, and graft modified products.

Further, other examples of the waxes include alcohols such as higher aliphatic alcohol, fatty acids such as stearic acid and palmitic acid, acid amides, esters, and ketones thereof, hydrogenated castor oil and derivatives thereof, vegetable waxes, and animal waxes. These may be used alone or in combination.

### Olefin Unit-Containing Polystyrene Resin B

The olefin unit-containing polystyrene resin B of the present disclosure is a copolymer of a styrene unit and an olefin unit having an olefin unit C.

The copolymer can be a block copolymer from the viewpoint of having more excellent stacking properties and a more excellent restorative force. When the block copolymer has one or more polyolefin segments having an olefin unit C and one or more polystyrene segments, the numbers of polymer blocks in the polyolefin segment and in the polystyrene segment, and the bonding forms thereof are not particularly limited. Examples of the block copolymer include the followings. In the following examples, S represents a polystyrene segment, O represents a polyolefin segment containing the olefin unit C, and n represents an integer of 2 or greater:
(a) a styrene-olefin copolymer represented by S—O;
(b) a styrene-olefin-styrene copolymer represented by S—O—S;
(c) an olefin-styrene-olefin copolymer represented by O—S—O;
(d) a styrene-olefin-styrene-olefin block copolymer represented by S—O—S—O; and
(e) a mixture of block copolymers in any combination of two or more of the above-described (a) to (d).

However, the block copolymer is not limited to the above-described (a) to (e) only. The block copolymer can be, for example, the (a), (b), or (e) that is a mixture of block copolymers as a combination of the above-described (a) and (b).

The olefin unit C contained in the polyolefin segment of the present disclosure has a structure represented by structural formula (1), (2), (3), or (4). In the following structural formulae, the structures have branches. In this manner, since the cohesiveness between the olefin units C is decreased, π-π stacking of aromatic rings of the styrene unit is promoted, and as a result, an effect of improving the restorative force is exhibited.

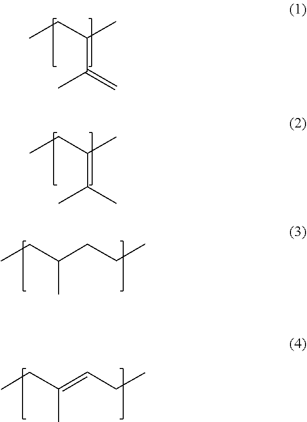

Among the structures, the structure represented by structural formula (1) or (2) is suitable from the viewpoint of further decreasing the cohesiveness between units, and the structure represented by structural formula (1) is more suitable from the viewpoint of having a more excellent affinity with the ester wax A.

The polyolefin segment may include an optional olefin unit in addition to the olefin unit C. Specifically, examples of the optional olefin unit include those derived from olefins such as ethylene, propylene, butene, and butadiene. In the polyolefin segment, the binding form between the olefin unit C and the optional olefin unit is not particularly limited, and blocks or random binding may be formed. The polyolefin segment is substantially composed of only the olefin unit C and the optional olefin unit. Specifically, 90% by mass or greater of the polyolefin segment is the olefin unit C and the optional olefin unit. More preferably, 98% by mass or greater of the polyolefin segment can be composed of the olefin unit C and the optional olefin unit. Even more preferably, the polyolefin segment can be composed of the olefin unit C and the optional olefin unit only.

The polystyrene segment is substantially formed of only a styrene unit. Specifically, the proportion of the styrene unit is 98% or greater on a mass basis. The polystyrene segment is suitably formed of only the styrene unit. Examples of units other than the styrene unit include styrene derivative units derived from styrene derivatives typified by vinyltoluene and α-methylstyrene, unsaturated fatty acid units derived from unsaturated fatty acids such as acrylic acid and methacrylic acid, acrylic acid ester units derived from acrylic acid ester such as methyl acrylate, ethyl acrylate, propyl acrylate, n-butyl acrylate, 2-ethylhexyl acrylate, and dimethylaminoethyl acrylate, and methacrylic acid ester units derived from methacrylic acid ester such as methyl methacrylate, ethyl methacrylate, propyl methacrylate, butyl methacrylate, 2-ethylhexyl methacrylate, and dimethylaminoethyl methacrylate.

The olefin unit-containing polystyrene resin B can be produced by a known method. Examples of the method of producing the olefin unit-containing polystyrene resin B include a method of sequentially polymerizing styrene and isoprene using an anionic living polymerization method to form polymer blocks and reacting the polymer blocks with a coupling agent as necessary to perform coupling. It is preferable that the total content of olefin units and styrene units in the olefin-unit-containing polystyrene resin B is 91% by mass or greater with respect to the total mass of the olefin-unit-containing polystyrene resin B, and more preferably 95% by mass or greater.

In the present disclosure, a commercially available block copolymer can also be used. Examples of the commercially available block copolymer include “SEPTON” and “HYBRAR” (both trade names, manufactured by KURARAY CO., LTD.), “QUINTAC” (trade name, manufactured by ZEON CORPORATION), “JSR-SIS” (trade name, manufactured by JSR Corporation), “Vector” (trade name, manufactured by DEXCO Polymers L.P.), and “ASAPRENE”, “TUFPRENE”, and “TUFTEC” (all trade names, manufactured by ASAHI KASEI CORPORATION). Further, examples of a commercially available random copolymer include “STYRENE/ISOPRENE COPOLYMER” (trade name, manufactured by Sigma-Aldrich).

### Binder Resin

The binder resin of the present disclosure can be a styrene acrylic copolymer. When the binder resin is a styrene acrylic copolymer, the olefin unit-containing polystyrene resin B can be compatible with the styrene moiety, and as a result, the adverse effect in an image is suppressed.

As the styrene acrylic copolymer, a known styrene acrylic copolymer of the related art can be used without particular limitation as long as the styrene acrylic copolymer is a copolymer of a monomer composition containing styrene and at least one acrylic monomer selected from acrylic acid and derivatives thereof including acrylic acid ester, and methacrylic acid and derivatives thereof including methacrylic acid ester. Here, the content of the styrene unit can be 60% by mass or greater and 90% by mass or less, or 70% by mass or greater and 80% by mass or less with respect to the total amount of the styrene acrylic copolymer. Further, the content of the acrylic unit can be 10% by mass or greater and 40% by mass or less, or 20% by mass or greater and 30% by mass or less.

Examples of the acrylic monomer include acrylic acid ester such as methyl acrylate or n-butyl acrylate, methacrylic acid ester such as methyl methacrylate, 2-hydroxyethyl methacrylate, t-butyl methacrylate, or 2-ethylhexyl methacrylate, acrylic acid, and methacrylic acid. Among these, acrylic acid ester or methacrylic acid ester can be used, n-butyl acrylate or methyl methacrylate can be suitably used, and n-butyl acrylate can be more suitably used.

In the styrene acrylic copolymer of the present disclosure, known polymerizable monomers of the related art can be used without particular limitation in addition to the styrene and the acrylic monomers described above. Specific examples thereof include monofunctional monomers having one polymerizable unsaturated bond in a molecule, for example, aromatic monomers such as α-methylstyrene and vinyltoluene, unsaturated dicarboxylic acids such as maleic acid, unsaturated dicarboxylic anhydrides such as maleic anhydrides, nitrile-based vinyl monomers such as acrylonitrile, halogen-based vinyl monomers such as vinyl chloride, and nitro-based vinyl monomers such as nitrostyrene, and polyfunctional monomers having a plurality of polymerizable unsaturated bonds in a molecule, for example, divinylbenzene, 1,6-hexanediol diacrylate, 1,9-nonanediol diacrylate, and trimethylolpropane tri(meth)acrylate.

Further, when a macromonomer is used as a part of the polymerizable monomer, the balance between the storage stability and the low-temperature fixability of the toner to be obtained can be enhanced. The macromonomer is a reactive oligomer or polymer that has a polymerizable carbon-carbon unsaturated double bond at a terminal of a molecular chain and usually has a number average molecular weight of 1000 or greater and 30000 or less. A macromonomer that provides a polymer having a glass transition temperature (hereinafter, also referred to as “Tg”) higher than the Tg of a polymer to be obtained by polymerizing a monovinyl monomer can be used as the macromonomer. The content of the macromonomer can be 0.03 parts by mass or greater and 5 parts by mass or less, or 0.05 parts by mass or greater and 1 part by mass or less with respect to 100 parts by mass of the monovinyl monomer.

Further, as the binder resin of the present disclosure, a known binder resin of the related art can be used without particular limitation, in addition to the above-described styrene acrylic copolymer. Specific examples thereof include a polyester resin, a vinyl-based resin, a polyurethane resin, and a polyamide resin.

### Colorant

The toner of the present disclosure may contain a colorant. As the colorant, known pigments and dyes of the colors of black, yellow, magenta, and cyan and other colors, and magnetic materials in the related art can be used without particular limitation.

Examples of the black colorant include black pigments such as carbon black.

Examples of the yellow colorant include yellow pigments and yellow dyes, such as a monoazo compound, a disazo compound, a condensed azo compound, an isoindolinone compound, a benzimidazolone compound, an anthraquinone compound, an azo metal complex, a methine compound, and an allylamide compound.

Specific examples thereof include C.I. Pigment Yellow 74, 93, 95, 109, 111, 128, 155, 174, 180, 185, and C.I. Solvent Yellow 162.

Examples of the magenta colorant include magenta pigments and magenta dyes, such as a monoazo compound, a condensed azo compound, a diketopyrrolopyrrole compound, an anthraquinone compound, a quinacridone compound, a base dye lake compound, a naphthol compound, a benzimidazolone compound, a thioindigo compound, and a perylene compound.

Specific examples thereof include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254, and 269, and C.I. Pigment Violet 19.

Examples of the cyan colorant include cyan pigments and cyan dyes, such as a copper phthalocyanine compound and derivatives thereof, an anthraquinone compound, and a base dye lake compound.

Specific examples thereof include C.I. Pigment Blue 1, 7, 15, 15:1, 15:2, 15:3, 15:4, 60, 62, and 66.

The content of the colorant can be 1.0 parts by mass or greater and 20.0 parts by mass or less with respect to 100.0 parts by mass of the binder resin.

Further, the toner can also be formed into a magnetic toner by containing a magnetic material. In this case, the magnetic material can also serve as a colorant.

Examples of the magnetic material include iron oxide typified by magnetite, hematite, or ferrite, metals typified by iron, cobalt, and nickel, alloys of these metals with metals such as aluminum, cobalt, copper, lead, magnesium, tin, zinc, antimony, beryllium, bismuth, cadmium, calcium, manganese, selenium, titanium, tungsten, and vanadium, and mixtures thereof.

When the magnetic material is used as the colorant, the content of the magnetic material can be 20.0 parts by mass or greater and 120.0 parts by mass or less with respect to 100.0 parts by mass of the binder resin.

### Charge Control Agent

As other additives, a positively or negatively charged charge control agent can be used for improving the chargeability of the toner. The charge control agent is not particularly limited as long as the charge control agent is an agent that has been typically used for toners. Among charge control agents, a positively or negatively charged charge control resin can be used from the viewpoint of imparting stabilized chargeability (charging stability) to toner particles.

Examples of the positively charged charge control agent include a nigrosine dye, a quaternary ammonium salt, a triaminotriphenylmethane compound, and an imidazole compound, as well as a polyamine resin, a quaternary ammonium group-containing copolymer, and a quaternary ammonium base-containing copolymer which are suitably used as the charge control resin. Among these, a quaternary ammonium group-containing copolymer or a quaternary ammonium base-containing copolymer can be more suitably used.

Examples of the negatively charged charge control agent include an azo dye containing a metal such as Cr, Co, Al, or Fe, a salicylic acid metal compound, and an alkylsalicylic acid metal compound, as well as a sulfonic acid group-containing copolymer, a sulfonate group-containing copolymer, a carboxylic acid group-containing copolymer, and a carboxylate group-containing copolymer which are suitably used as the charge control resin.

The weight-average molecular weight (Mw) of the charge control resin is in a range of 5000 or greater and 30000 or less in terms of polystyrene, which is measured by gel permeation chromatography (GPC) using tetrahydrofuran, and can be in a range of 8000 or greater and 25000 or less, or in a range of 10000 or greater and 20000 or less.

Further, the copolymerization ratio of monomers containing functional groups such as a quaternary ammonium group and a sulfonate group in the charge control resin is in a range of 0.5% by mass or greater and 12% by mass or less, and can be in a range of 1.0% by mass or greater and 6% by mass or less, or in a range of 1.5% by mass or greater and 3% by mass or less.

In the present disclosure, the proportion of the charge control agent in 100 parts by mass of the binder resin is usually 0.01 parts by mass or greater and 10 parts by mass or less and can be 0.03 parts by mass or greater and 8 parts by mass or less. When the amount of the charge control agent to be added is 0.01 to 10 parts by mass, both the risk of fogging and the risk of print stains are low.

### External Additive

The toner of the present disclosure may contain an external additive. The external additive is not particularly limited, and a known external additive of the related art can be used. Examples of the external additive include raw material silica fine particles such as wet process silica and dry process silica, surface-treated silica fine particles obtained by performing a surface treatment on these raw material silica fine particles with a treatment agent such as a silane coupling agent, a titanium coupling agent, or silicone oil, metal oxide fine particles typified by titanium oxide fine particles, aluminum oxide fine particles, and zinc oxide fine particles, metal oxide fine particles obtained by performing a hydrophobic treatment on metal oxides, fatty acid metal salts typified by zinc stearate and calcium stearate, metal complexes of an aromatic carboxylic acid typified by salicylic acid, alkyl salicylic acid, dialkyl salicylic acid, naphthoic acid, and dicarboxylic acid, clay minerals typified by hydrotalcite, and fluorine-based resin fine particles typified by vinylidene fluoride fine particles and polytetrafluoroethylene fine particles.

The content of the external additive can be 0.1 parts by mass or greater and 5.0 parts by mass or less with respect to 100.0 parts by mass of the toner particles.

### Average Circularity

The toner of the present disclosure can have an average circularity (specific measuring method will be described below) of 0.960 or greater and 0.995 or less. When the circularity is maintained in a range where deformation is small, the adverse effects in an image, including development stripe, are suppressed.

### Method of Obtaining Toner of the Present Disclosure

Next, a method of obtaining the toner of the present disclosure will be described in detail.

### Method of Producing Toner Particles

The method of producing toner particles of the present disclosure is not particularly limited, and a suspension polymerization method, a dissolution suspension method, an emulsion aggregation method, a pulverization method, or the like can be used. Among these, a suspension polymerization method can be suitably used.

Hereinafter, a method of obtaining the toner using the suspension polymerization method will be described in detail.

### Step 1: Granulation Step

A polymerizable monomer composition containing a polymerizable monomer, a colorant, an olefin unit-containing polystyrene resin B, and an ester wax A is dispersed in an aqueous medium containing a dispersion stabilizer, a polymerization initiator is added thereto, and liquid droplets of the polymerizable monomer composition is performed. A method of forming the liquid droplets is not particularly limited, and the liquid droplets can be formed by using a device capable of performing strong stirring, for example, an (in-line type) emulsifying disperser (trade name: MILDER, manufactured by Pacific Machinery & Engineering Co., Ltd.) or a high-speed emulsifying disperser (trade name: T.K. Homo Mixer MARK II Type, manufactured by Primix Corporation).

Examples of the polymerization initiator include a persulfate such as potassium persulfate or ammonium persulfate, an azo compound such as 4,4′-azobis(4-cyanovaleric acid), 2,2′-azobis(2-methyl-N-(2-hydroxyethyl) propionamide), 2,2′-azobis(2-amidinopropane) dihydrochloride, 2,2′-azobis(2,4-dimethylvaleronitrile), or 2,2′-azobisisobutyronitrile, and an organic peroxide such as di-t-butyl peroxide, benzoyl peroxide, t-butylperoxy-2-ethylhexanoate, t-hexylperoxy-2-ethylbutanoate, diisopropyl peroxydicarbonate, di-t-butylperoxy isophthalate, or t-butylperoxy isobutyrate. These polymerization initiators may be used alone or in combination of two or more kinds thereof. Among these, an organic peroxide can be used from the viewpoint of reducing the amount of residual polymerizable monomers and having excellent print durability.

Among organic peroxides, from the viewpoint of having satisfactory initiator efficiency and reducing the amount of residual polymerizable monomers, peroxy ester is suitably used, and non-aromatic peroxy ester, that is, peroxy ester having no aromatic ring is more suitably used.

The polymerization initiator may be added to the polymerizable monomer composition after the polymerizable monomer composition is dispersed in an aqueous medium and before liquid droplets are formed, or may be added before the polymerizable monomer composition is dispersed in an aqueous medium.

The amount of the polymerization initiator used for polymerizing the polymerizable monomer composition can be 0.1 parts by mass or greater and 20 parts by mass or less, 0.3 parts by mass or greater and 15 parts by mass or less, or 1 part by mass or greater and 10 parts by mass with respect to 100 parts by mass of the monomer.

In the present disclosure, the aqueous medium is a medium containing water as a main component.

In the present disclosure, the aqueous medium can contain a dispersion stabilizer. Examples of the dispersion stabilizer include inorganic compounds, for example, persulfates such as barium sulfate and calcium sulfate, carbonates such as calcium carbonate and magnesium carbonate, phosphates such as calcium phosphate, metal oxides such as aluminum oxide and titanium oxide, and metal hydroxides such as aluminum hydroxide, magnesium hydroxide, and ferric hydroxide, and organic compounds, for example, water-soluble polymers such as polyvinyl alcohol, methyl cellulose, and gelatin, anionic surfactants, nonionic surfactants, and amphoteric surfactants.

The above-described dispersion stabilizers can be used alone or in combination of two or more kinds thereof. The amount of the dispersion stabilizer to be added can be 0.1 part by mass or greater and 20 parts by mass or less, or 0.2 parts by mass or greater and 10 parts by mass or less with respect to 100 parts by mass of the polymerizable monomer.

Among the above-described dispersion stabilizers, inorganic compounds and particularly sparingly water-soluble metal hydroxides can be used. The particle size distribution of the toner particles can be narrowed and the amount of the dispersion stabilizer remaining after washing can be decreased by using inorganic compounds and particularly colloids of sparingly water-soluble metal hydroxides. Therefore, the toner to be obtained can reproduce images clearly, and the environmental stability is not degraded.

### Step 2: Polymerization Step

The liquid droplets are formed as described in the step 1, the obtained aqueous dispersion medium is heated, polymerization is initiated, and an aqueous dispersion liquid of resin particles containing a binder resin, a colorant, an olefin unit-containing polystyrene resin B, and an ester wax A is formed.

The polymerization temperature of the polymerizable monomer composition can be 50° C. or higher, or 60° C. to 95° C. Further, the reaction time of the polymerization can be 1 to 20 hours, or 2 to 15 hours.

In order to perform polymerization in a state where the liquid droplets of the polymerizable monomer composition are stably dispersed, the polymerization reaction may be promoted while the dispersion treatment is performed by stirring the liquid droplets even in the present polymerization step successively to the step 1 described above.

The resin particles may also be used as a toner as they are or with the addition of an external agent, but the resin particles can be formed into so-called core-shell type (or also referred to as “capsule type”) resin particles obtained by using the resin particles as a core layer and forming a shell layer different from the core layer on the outside of the core layer. The core-shell type resin particles can achieve the balance between decreasing the fixing temperature and preventing aggregation during storage by coating the core layer made of a substance having a low softening point with a substance having a softening point higher than the softening point of the substance forming the core layer.

A method of producing the above-described core-shell type toner particles using the resin particles is not particularly limited, and the core-shell type toner particles can be produced by a known method of the related art. From the viewpoint of production efficiency, an in situ polymerization method or a phase separation method can be used.

The method of producing the core-shell type resin particles using the in situ polymerization method will be described below.

The core-shell type resin particles can be obtained by adding a polymerizable monomer (polymerizable monomer for a shell) for forming a shell layer and a polymerization initiator to an aqueous medium in which the toner particles are dispersed and carrying out polymerization.

As the polymerizable monomer for a shell, the same polymerizable monomers as described above can be used. Among these, the monomers capable of providing polymers having a Tg of higher than 80° C., such as styrene, acrylonitrile, and methyl methacrylate, can be used alone or in combination of two or more kinds thereof.

Examples of the polymerization initiator used for polymerizing the polymerizable monomer for a shell include water-soluble polymerization initiators, for example, metal persulfates such as potassium persulfate and ammonium persulfate, and azo-based initiators such as 2,2′-azobis(2-methyl-N-(2-hydroxyethyl) propionamide) and 2,2′-azobis-(2-methyl-N-(1,1-bis(hydroxymethyl) 2-hydroxyethyl) propionamide). These polymerization initiators can be used alone or in combination of two or more kinds thereof. The mount of the polymerization initiator can be 0.1 parts by mass or greater and 30 parts by mass, or 1 part by mass or greater and 20 parts by mass or less with respect to 100 parts by mass of the polymerizable monomer for a shell.

The polymerization temperature of the shell layer can be 50° C. or higher, or 60° C. to 95° C. Further, the reaction time for the polymerization can be 1 to 20 hours, or 2 to 15 hours.

### Step 3: Volatile Component Removal Step

A volatile component removal step may be performed to remove unreacted polymerizable monomers and the like from a resin particle dispersion liquid after the completion of the polymerization step. The volatile component removal step is performed by heating and stirring the resin particle dispersion liquid in a stirring tank provided with a stirrer. The heating conditions during the volatile component removal step are appropriately adjusted in consideration of the vapor pressure of the component intended to be removed, such as polymerizable monomers. The volatile component removal step can be performed under normal pressure or reduced pressure.

### Post Steps: Washing, Filtration, Dehydration, Drying, and Classification

The aqueous dispersion liquid of the resin particles produced by the above-described steps is subjected to washing, filtration, dehydration, drying, and classification steps using usual methods, thereby obtaining toner particles.

When an inorganic compound is used as the dispersion stabilizer as the washing method, the dispersion stabilizer can be dissolved in water and removed by adding an acid or an alkali to the aqueous dispersion liquid of the toner particles. When a colloid of a sparingly water-soluble inorganic hydroxide is used as the dispersion stabilizer, the pH of the aqueous dispersion liquid of the toner particles can be adjusted to 6.5 or less by adding an acid to the aqueous dispersion liquid. As the acid to be added, an inorganic acid such as sulfuric acid, hydrochloric acid, or nitric acid, or an organic acid such as formic acid or acetic acid can be used. Among these, from the viewpoints of high removal efficiency and a lesser burden on the production facilities, sulfuric acid can be used.

The dehydration and filtration methods are not particularly limited, and various known methods and the like can be used. Examples thereof include a centrifugal filtration method, a vacuum filtration method, and a pressure filtration method. Further, the drying method is also not particularly limited, and various methods can be used.

### Method of Producing Toner

When an external additive is added to the toner particles to obtain a toner (toner product), a mixer for adding an external additive to the toner particles is not particularly limited, and any known mixers including dry type and wet type mixers can be used. Examples thereof include an FM Mixer (manufactured by NIPPON COKE & ENGINEERING CO., LTD.) a Super Mixer (manufactured by KAWATA MFG. CO., LTD.), NOBILTA (manufactured by Hosokawa Micron Corporation), and Hybridizer (manufactured by Nara Machinery Co., Ltd.). In order to control the coating state of the external additive, the rotation speed of the external addition device, the treatment time, and the water temperature and the amount of water of the jacket can be adjusted to prepare the toner.

Examples of a sieving device used for sift out coarse particles after the external addition include ULTRASONIC (manufactured by KOEI SANGYO CO., LTD.), Resonasieve and Gyro-sifter (manufactured by TOKUJU CORPORATION), Vibrasonic System (manufactured by DALTON CORPORATION), SONICLEAN (manufactured by SINTOKOGIO, LTD.), TURBO-SCREENER (manufactured by FREUND-TURBO CORPORATION), and MICRO SIFTER (manufactured by MAKINO MFG. CO., LTD.).

### Method of Measuring Physical Properties

Hereinafter, methods of measuring the physical properties of the toner and each material will be described.

### Measurement of Glass Transition Temperature (Tg) of Resin Particles (Toner Particles)

The glass transition temperature (Tg) is measured in conformity with ASTM D3418-82 using a differential scanning calorimeter “Q1000” (manufactured by TA Instruments). The melting points of indium and zinc are used for correcting the temperature of a device detection unit, and heat of fusion of indium is used for correcting the heat quantity. Specifically, about 3 mg of resin particles are precisely weighed and placed in an aluminum pan, and the measurement is performed in a temperature range of 30° C. to 200° C. at a temperature increase rate of 10° C./min using an empty aluminum pan as a reference. In the temperature increase process, a change in specific heat is obtained in a temperature range of 40° C. to 100° C. The straight line extending the baseline before the change in specific heat is defined as a first straight line, the straight line extending the baseline after the change in specific heat is defined as a second straight line, and the straight line that is equidistant from the first straight line and the second straight line in a longitudinal axis direction is defined as a third straight line. The temperature at the intersection between the third straight line and the stepwise change portion of the differential thermal curve (that is, so-called midpoint glass transition temperature) is defined as the glass transition temperature Tg of the resin particles.

### Identification of Ester Wax A in Toner

(1) Method of Separating Wax from Toner

First, the melting point of the wax in the toner is measured using a thermal analyzer (DSC Q2000, manufactured by TA Instruments). 3.0 mg of the toner sample is put into a sample container of an aluminum pan (KIT No. 0219-0041), and the sample container is placed on a holder unit and set in an electric furnace. The sample container is heated from 30° C. to 200° C. at a temperature increase rate of 10° C./min in a nitrogen atmosphere, a DSC curve is measured using a differential scanning calorimeter (DSC), and the melting point of the wax in the toner sample is calculated.

Next, the toner is dispersed in ethanol, which is a poor solvent for the toner, and heated to a temperature higher than the melting point of the wax. Here, the toner may be pressurized as necessary. The wax at the temperature higher than the melting point is melted and extracted into methanol by performing this process. When the toner is heated and further pressurized, the wax can be separated from the toner by performing solid-liquid separation in a state where the toner is pressurized. Next, the extracted liquid is dried and solidified to obtain the wax.

### (2) Identification of Wax Using Pyrolysis-GCMS

Specific conditions for identifying the wax using pyrolysis-GCMS are described below.
Mass spectrometer: ISQ (manufactured by Thermo Fisher Scientific Inc.)
GC device: Focus GC (manufactured by Thermo Fisher Scientific Inc.)
Ion source temperature: 250° C.
Ionization method: EI
Mass range: 50 to 1000 m/z
Column: HP-5 MS [30 m]
Pyrolyzer: JPS-700 (manufactured by Japan Analytical Industry Co., Ltd.)

A small amount of the wax separated by the extraction operation and 1 μL of tetramethylammonium hydroxide (TMAH) are added to pyrofoil at 590° C. The prepared sample undergoes pyrolysis-GCMS measurement under the above-described conditions, thereby obtaining peaks derived from the wax. When the wax is an ester compound, peaks for each of an alcohol component and a carboxylic acid component are obtained. Due to the action of TMAH, which is a methylating agent, the alcohol component and the carboxylic acid component are detected as methylated materials.

The molecular weight can also be obtained by analyzing the obtained peaks and identifying the structure of the wax.

### Method of Measuring Melting Point

The melting point of the crystalline material (wax) is measured using a differential scanning calorimeter (DSC) Q2000 (manufactured by TA Instruments).

Temperature increase rate: 10° C./min
Measurement start temperature: 20° C.
Measurement end temperature: 180° C.

The melting points of indium and zinc are used for correcting the temperature of a device detection unit, and heat of fusion of indium is used for correcting the heat quantity.

Specifically, about 5 mg of the sample is precisely weighed and placed in an aluminum pan, and the measurement is performed once. An empty aluminum pan is used as a reference. Here, the peak temperature of the maximum endothermic peak is defined as the melting point.

### Separation of Olefin Unit-Containing Polystyrene Resin B

A chloroform soluble matter of the toner particles is used as a sample. The sample is prepared such that the concentration of the toner particles in chloroform reaches 0.1% by mass, and the solution is filtered through a PTFE filter having a pore size of 0.45 μm and used in the measurement. The conditions for gradient polymer LC measurement are as follows.
Device: ULTIMATE 3000 (manufactured by Thermo Fisher Scientific Inc.)
Mobile phase: A chloroform (HPLC), B acetonitrile (HPLC)
Gradient: 2 min (A/B=0/100)→25 min (A/B=100/0)
   (Further, the gradient in a change of the mobile phase is set to be a straight line.)
Flow rate: 1.0 mL/min
Injection: 0.1% by mass×20 μL
Column: Tosho TSKgel ODS (4.6 mm×150 mm×5 μm)
Column temperature: 40° C.
Detector: Corona charged particle detector (Corona-CAD) (manufactured by Thermo Fisher Scientific Inc.)

In the time-intensity graph obtained by the measurement, the resin component can be separated into two peaks depending on the polarity. Thereafter, the above-described measurement is performed again, fractionation is carried out at the time when the peaks form a valley, and thus two types of separated resins can be obtained. In the present measurement, components with higher solubility in acetonitrile are eluted earlier. Therefore, the binder resin, and the olefin unit-containing polystyrene resin B are eluted in this order. The peaks corresponding to the resins are confirmed, fractionation is performed at the timing of confirmation, and thus fractions containing the binder resin and the olefin unit-containing polystyrene resin B are collected. The fractions are dried and concentrated, thereby obtaining a sample of the olefin unit-containing polystyrene resin B. Further, the toner particles containing components other than the resin binder and the olefin unit-containing polystyrene resin B are subjected to the same operation described above, and as a result, fractions can be collected.

When the toner contains a release agent, the release agent is required to be separated from the toner. In the separation of the release agent, components having a molecular weight of 2000 or less are separated by recycling HPLC. The measuring method is as follows. First, a chloroform solution of the toner is prepared by the above-described method. In addition, the obtained solution is filtered through a solvent-resistant membrane filter “MYSHORIDISC” (manufactured by Tosoh Corporation) having a pore size of 0.2 μm to obtain a sample solution. Further, the sample solution is prepared such that the concentration of the component soluble in THF is adjusted to 1.0% by mass. The measurement is performed using this sample solution under the following conditions.
Device: LC-Sakura NEXT (manufactured by Japan Analytical Industry Co., Ltd.)
Column: JAIGEL 2H and 4H (manufactured by Japan Analytical Industry Co., Ltd.)
Eluent: chloroform
Flow rate: 10.0 mL/min
Oven temperature: 40.0° C.
Sample injection volume: 1.0 mL

The molecular weight of each sample is calculated by using a molecular weight calibration curve prepared with a standard polystyrene resin (for example, trade name “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation).

The components having a molecular weight of 2000 or less are repeatedly fractionated from the molecular weight curve obtained as described above, and the release agent is removed from the toner.

### Identification of Olefin Unit C in Olefin Unit-Containing Polystyrene Resin B, Verification of Block Structure of the Block Copolymer and Measurement of Content Proportion

The identification, the verification and the measurement of the content proportion of the olefin unit C in the olefin unit-containing polystyrene resin B are performed using ¹H-NMR under the following conditions.
Measuring device: FT NMR device JNM-EX400 (manufactured by JEOL Ltd.)
Measuring frequency: 400 MHz
Pulse condition: 5.0 μs
Frequency range: 10500 Hz
Number of times of integration: 64 times
Measurement temperature: 30° C.
Sample: 50 mg of a measurement sample is placed in a sample tube having an inner diameter of 5 mm, deuterated chloroform (CDCl₃) is added as a solvent, and the mixture is dissolved in a thermostatic bath at 40° C. to prepare the sample.

The obtained ¹H-NMR chart is analyzed to identify the structure of each monomer unit. In the obtained ¹H-NMR chart, a peak independent of peaks attributed to constituent elements of monomer units other than the olefin unit C is selected from peaks attributed to constitutional unit of the olefin unit C, and an integral value S1 of this peak is calculated. The integral values of the peaks of the other monomer units contained in the olefin unit-containing polystyrene resin B are calculated in the same manner as described above.

When the monomer units constituting the olefin unit-containing polystyrene resin B are the olefin unit C and one other monomer unit, the content proportion of the olefin unit C is determined in the following manner using the integral value S1 and an integral value S2 of the peaks of the other monomer unit. In addition, n1 and n2 are numbers of hydrogen atoms in the constituent elements into which the peaks for each site are attributed.

$$Content proportion ( \% by mass ) of olefin unit C = \{ ( S 1 / n 1 ) / ( ( S 1 / n 1 ) + ( S 2 / n 2 ) ) \} \times 100$$

When two or more kinds of monomer units are present as the other monomer unit, the content proportion of the olefin unit C can be calculated in the same manner as described above.

Further, when a polymerizable monomer containing no hydrogen atom is used in the constituent element other than the vinyl group, the measurement is performed in a single pulse mode using ¹³C-NMR and a measurement atomic nucleus as ¹³C, and the calculation is performed in the same manner as in ¹H-NMR. The content proportion of each monomer unit is converted into the mass percentage by multiplying the proportion (% by mole) of each monomer unit calculated using the above-described method by the molecular weight of each monomer unit.

The fact that the olefin unit-containing polystyrene resin B is a block copolymer having the polyolefin segment and the polystyrene segment can be confirmed from the ratio of the peak originating from the carbon atoms between olefin units, the peak originating from the carbon atoms between styrene units, and the peak originating from the carbon atoms between styrene unit and olefin unit in the 13C-NMR chart obtained by the above-described method. As an example, the carbon atom between olefin units is shown in formula (8), the carbon atom between styrene units is shown in formula (9), and the carbon atom between styrene unit and olefin unit is shown in formula (10), respectively. In formulae (8) to (10), the carbon atoms indicated by arrows correspond to the aforementioned carbon atoms. Specifically, when a value (S_{I}/S_{SI}) of a ratio of an integral value (S_{I}) of the peak originating from the carbon atoms between olefin units to an integral value (S_{SI}) of the peak originating from the bond between styrene unit and olefin unit is 10 or greater, and a value (S_{S}/S_{SI}) of a ratio of an integral value (S_{S}) of the peak originating from the carbon atoms between styrene units to an integral value (S_{SI}) of the peak originating from the bond between styrene unit and olefin unit is 5 or greater, the olefin unit-containing polystyrene resin B is determined to be a block copolymer having the polyolefin segment and the polystyrene segment. It is also possible to determine whether the polyolefin segment contains the olefin unit C from the peak position of the ¹³C-NMR chart.

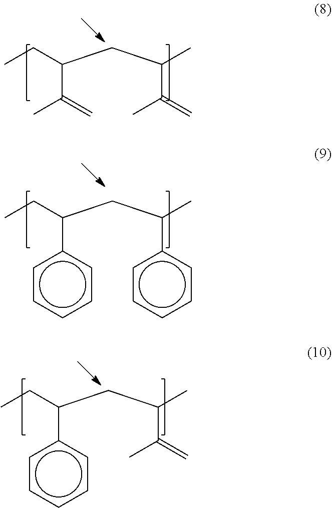

### Method of Measuring Average Circularity of Toner (Particles)

The average circularity of the toner or the toner particles is measured using a flow type particle image analyzer “FPIA-3000” (manufactured by Sysmex Corporation) under measurement and analysis conditions during the calibration work. An appropriate amount of an alkylbenzene sulfonate serving as a surfactant is added to 20 mL of ion exchange water as a dispersant, 0.02 g of a measurement sample is added thereto, and a dispersion treatment is performed on the mixture for 2 minutes using a table top ultrasonic cleaner disperser (trade name: VS-150, manufactured by VELVO-CLEAR) at an oscillation frequency of 50 kHz and an electrical output of 150 watts to obtain a dispersion liquid for measurement. In this case, the dispersion liquid is appropriately cooled such that the temperature of the dispersion liquid is 10° C. to 40° C. The measurement is performed by using the flow type particle image analyzer equipped with a standard objective lens (10 times) and a particle sheath “PSE-900A” (manufactured by Sysmex Corporation) as a sheath liquid. The dispersion liquid prepared by the above-described procedures is introduced to the flow type particle image analyzer, 3000 toner (particles) are measured in a total count mode and an HPF measurement mode, the binarization threshold value during particle analysis is set to 85%, the particle diameter for analysis is limited to an equivalent circle diameter of 1.98 μm to 19.92 μm, thereby determining the average circularity of the toner (particles). In the measurement, automatic focus adjustment is performed using standard latex particles (for example, 5100A (trade name, manufactured by Duke Scientific Corporation) diluted with ion exchange water) before the start of measurement. Thereafter, focus adjustment can be performed every two hours from the start of measurement.

### Method of Measuring Weight-Average Particle Diameter (D4) and Number Average Particle Diameter (D1)

The weight-average particle diameter (D4) and the number average particle diameter (D1) of the toner, toner particles, or toner base particles (hereinafter, also referred to as the toner or the like) are calculated in the following manner.

A precision particle size distribution measuring device “COULTER COUNTER Multisizer 3” (registered trademark, manufactured by Beckman Coulter, Inc.) provided with an aperture tube having a diameter of 100 μm is used as a measuring device.

Dedicated software “BECKMAN COULTER Multisizer 3 Version 3.51” (manufactured by Beckman Coulter, Inc.) attached to the device is used for setting measurement conditions and analyzing measurement data. Further, the measurement is performed with 25000 effective measuring channels.

An electrolyte solution obtained by dissolving special grade sodium chloride in ion exchange water and adjusting the concentration thereof to about 1.0% by mass, for example, “ISOTON II” (manufactured by Beckman Coulter, Inc.) can be used as the electrolyte solution used for the measurement.

In addition, dedicated software is set up in the following manner before the measurement and the analysis.

In the “changing standard measuring method (SOMME)” screen of the dedicated software, the total count number in the control mode is set to 50000 particles, the number of times of measurement is set to once, and a value obtained by using “nominal particle 10.0 μm” (manufactured by Beckman Coulter, Inc.) is set as the Kd value. The threshold value and the noise level are automatically set by pressing the “measurement button of the threshold value/noise level”. Further, the current is set to 1600 μA, the gain is set to 2, the electrolyte solution is set as ISOTON II, and the “aperture tube flash after measurement” is checked.

In the “setting for converting pulse into particle diameter” screen of the dedicated software, the bin interval is set to the logarithmic particle diameter, the particle diameter bin is set to 256 particle diameter bin, and the particle diameter is set to be in a range of 2 μm to 60 μm.

The specific measuring method is as follows:
(1) A 250 mL round-bottom glass beaker for exclusive use of Multisizer 3 is charged with about 200.0 mL of the electrolyte solution and set on a sample stand, and the solution is stirred with a stirrer rod at 24 rotations/sec in a counterclockwise direction. Further, the stains and air bubbles inside the aperture tube are removed by the function of “aperture tube flash” of the dedicated software.
(2) A 100 mL flat-bottom glass beaker is charged with about 30.0 mL of the electrolyte solution. Further, 0.3 mL of a diluent obtained by diluting “Contaminon N” (10 mass % aqueous solution of neutral detergent for washing precision measuring machine with pH of 7, which is formed of nonionic surfactant, anionic surfactant, and organic builder, manufactured by FUJIFILM Wako Pure Chemical Corporation) to 3 times by mass with ion exchange water is added thereto as a dispersant.
(3) An ultrasonic disperser “Ultrasonic Dispersion System Tetora 150” (manufactured by Nikkaki Bios Co., Ltd.) with an electrical output of 120 W, which is provided with two built-in oscillators having an oscillation frequency of 50 kHz in a state of a phase shift of 180 degrees. 3.3 L of ion exchange water is added to a water tank of the ultrasonic disperser, and 2.0 mL of Contaminon N is added to the water tank.
(4) The beaker of the item (2) is set in a beaker fixing hole of the ultrasonic disperser, and the ultrasonic disperser is operated. Further, the position of the height of the beaker is adjusted such that the resonance state of the liquid level of the electrolyte solution in the beaker is maximized.
(5) The electrolyte solution in the beaker of the item (4) is irradiated with ultrasonic waves, and 10 mg of the toner and the like are added to the electrolyte solution little by little and dispersed therein. Further, an ultrasonic dispersion treatment is further continued for 60 seconds. In addition, the water temperature in the water tank is appropriately adjusted to 10° C. or higher and 40° C. or lower in the ultrasonic dispersion treatment.
(6) The electrolyte solution of the item (5) in which the toner and the like have been dispersed using a pipette is added dropwise to the round-bottom beaker of the item (1) disposed in the sample stand, and the measurement concentration is adjusted to about 5%. Further, the measurement is performed until the number of measured particles reaches 50000.
(7) The weight-average particle diameter (D4) and the number average particle diameter (D1) are calculated by analyzing the measurement data using the dedicated software attached to the device. Further, “average diameter” in the “analysis/volume statistics (arithmetic average)” screen is the weight-average particle diameter (D4) when the graph/volume % is set in the dedicated software.

In addition, “average diameter” in the “analysis/number statistics (arithmetic average)” screen is the number average particle diameter (D1) when the graph/number % is set in the dedicated software.

### Image Forming Apparatus

FIGURE is a view showing a schematic configuration of an example of an image forming apparatus according to an embodiment of the present disclosure. The overall configuration of the image forming apparatus will be described with reference to FIGURE. However, the constituent components, the dimensions, the arrangement, and the like in this configuration example are appropriately changed, and do not limit the scope of the present disclosure. FIGURE is a schematic cross-sectional view showing an image forming apparatus 100 which is a laser printer capable of forming monochrome images (black monochrome images) using an electrophotographic method.

The image forming apparatus 100 includes a rotatable drum type (cylindrical) photosensitive member (photosensitive drum) 11 serving as an electrostatic latent image bearing member. When an image forming operation is started, the photosensitive member 11 rotates and is driven in a direction indicated by an arrow A1 in the drawing (clockwise direction) by a driving force transmitted from a driving motor serving as a driving source constituting a driving unit.

The surface of the rotating photosensitive member 11 is uniformly charged to a predetermined potential of predetermined polarity that is the normal polarity of the toner by a charging roller 21 that is a roller type charging member serving as a charging unit. The surface (outer peripheral surface) of the charging roller 21 comes into contact with the surface (outer peripheral surface) of the photosensitive member 11 to form a charging unit N2.

Both end portions of the charging roller 21 are pressurized with a spring in a rotation axis direction of a conductive support so that the charging roller 21 is brought into contact with the surface of the photosensitive member 11 due to a predetermined pressure.

The charging roller 21 rotates according to the rotation of the photosensitive member 11. During the charging treatment, a predetermined charging voltage (charging bias) is applied to the charging roller 21 at a predetermined timing from a charging power source serving as a charging voltage application unit. The uniformly charged surface (non-image area) of the photosensitive member 11 has a dark potential.

The charged surface of the photosensitive member 11 is scanned and exposed by an exposure device (laser exposure unit) 131 serving as an exposure unit (electrostatic image forming unit) to form an electrostatic latent image (electrostatic image) on the photosensitive member 11. The exposure device 131 scans the surface of the photosensitive member 11 and exposes the surface to a laser beam in a main scanning direction (substantially parallel to the rotation axis direction of the photosensitive member 11) of the photosensitive member 11 according to image information (image data). Further, the exposure device 131 repeats exposure in the main scanning direction according to the image information by adjusting the timing in a sub-scanning direction (substantially parallel to a movement direction of the surface of the photosensitive member 11). In this manner, an electrostatic latent image is formed on the photosensitive member 11. The exposed portion (image area) which is the exposed surface of the photosensitive member 11 has a bright potential.

The electrostatic latent image formed on the photosensitive member 11 is developed (visualized) by a developing device (developing unit) 2 serving as a developing unit by a toner T being supplied as a developer so that a toner image (developer image) is formed on the photosensitive member 11. In the present disclosure, one-component toner is used as the developer accommodated in the developing device 2. The details of the toner are as described above.

The developing device 2 includes a developing roller 31 serving as a toner bearing member (developing member). During the development, the surface (outer peripheral surface) of the developing roller 31 is brought into contact with the surface (outer peripheral surface) of the photosensitive member 11 to form a developed portion N1. Further, a predetermined developing voltage (developing bias) is applied to the developing roller 31 at a predetermined timing from a developing power source serving as a developing voltage application unit. The toner charged with the same polarity as the charging polarity of the photosensitive member 11 adheres to the exposed portion (image area) on the photosensitive member 11 where the absolute value of the potential is decreased by exposure after being uniformly charged (reversal developing method).

Since the development is performed using a potential difference (development contrast) formed between the developing voltage to be applied to the developing roller 31 and the bright potential on the photosensitive member 11, a predetermined developing voltage is applied to the developing roller 31. The magnitude of the surface potential formed on the surface of the developing roller 31 and the magnitude of the developing voltage applied to the developing roller 31 are set to be substantially the same as each other. The developing roller 31 rotates in a direction indicated by an arrow A2 (counterclockwise direction) (the movement direction in the contact portion is the forward direction) in the drawing, which is opposite to the direction of the photosensitive member 11. The developing device 2 will be further described below.

A transfer roller 111, which is a roll type transfer member, serving as a transfer unit is disposed to face the photosensitive member 11. The transfer roller 111 is pressed against the photosensitive member 11 to form a transfer portion (transfer nip) N3 which is a contact portion between the photosensitive member 11 and the transfer roller 111. The toner image formed on the photosensitive member 11 is transferred, by the action of the transfer roller 111 in the transfer portion N3, onto a recording material R to be transported in a state of being sandwiched between the photosensitive member 11 and the transfer roller 111. During the transfer, a predetermined transfer voltage (transfer bias) is applied to the transfer roller 111 at a predetermined timing from a transfer power source serving as a transfer voltage application unit.

A sheet-like recording material (a transfer material, a recording medium, or a sheet) R, such as paper, is supplied to the transfer unit N3 from a paper feeding unit (paper sending unit) 181. The paper feeding unit 181 may include a cassette as a recording material accommodating unit, a transport roller as a transport member, and the like. The recording material R is transported to the transfer unit N3 by adjusting the timing to that of the toner image on the photosensitive member 11.

The recording material R to which the toner image has been transferred is transported to a fixing device 121 serving as a fixing unit. The fixing device 121 applies heat and a pressure to the recording material R bearing the unfixed toner image to fix (melt or stick) the toner image to the recording material R. The recording material R to which the toner image has been fixed is discharged (output) from a paper discharge unit (discharge unit) 191, and stacked on a tray 192 provided on an upper portion of the image forming apparatus 100.

In the present configuration example, the photosensitive member 11, the charging roller 21 serving as a process unit acting on the photosensitive member 11, and the developing device 2 integrally constitute a process cartridge 1 that is detachably attached to the image forming apparatus 100. Further, the transfer roller 111, the exposure device 131, the fixing device 121, a pre-exposure unit 6, a control unit 141 that controls the developing device 2, various power sources, and the like are attached to the image forming apparatus 100. The image forming apparatus and the process cartridge may have a cleaning blade (not shown) for cleaning the toner on the surface of the photosensitive member 11.

### Process Cartridge

Next, the process cartridge 1 of the present configuration example will be described in more detail.

The process cartridge 1 is configured to include the developing device (developing unit) 2 and a photosensitive member unit 3. As described below, the developing device 2 includes a developing roller 31, a supply roller 32, a developing blade 33, a developing container 36 that also serves as a developer accommodating unit. The developing container 36 also serves as a developing frame that supports the developing roller 31, the supply roller 32, and the developing blade 33.

The photosensitive member unit 3 includes the photosensitive member 11 and the charging roller 21 and supports each of these members. Further, the developing device 2 and the photosensitive member unit 3 are bonded to each other such that the developing device 2 is swingable relative to the photosensitive member unit 3 about the rotation axis substantially parallel to the rotation axis direction of the photosensitive member 11. More specifically, the process cartridge 1 is integrated by bonding the developing container (developing frame) 36 of the developing device 2 and a photosensitive member support container (photosensitive member unit frame) 61 of the photosensitive member unit 3 in a swingable manner.

In this manner, the developing device 2 can move between a contact position where the developing roller 31 is brought into contact with the photosensitive member 11 and a separated position where the developing roller 31 is separated from the photosensitive member 11. When the developing device 2 is configured such that the developing device 2 can move between the contact position and the separated position, the developing device 2 and the photosensitive member 11 are suppressed from being unnecessarily worn. That is, in the separated position, the drive of the developing device 2 is stopped to stop the rotation of the developing roller 31 and the supply roller 32, the toner is suppressed from being worn, the photosensitive member 11 does no longer come into contact with the developing roller 31, and thus abrasion of the charge transport layer is suppressed.

### Developing Device

Next, the developing device (developing unit) 2 in the present configuration example will be further described. The developing device 2 includes a developing roller 31 serving as a developer bearing member (developing member) that bears and transports the toner serving as a developer and supplies the toner to the electrostatic latent image formed on the surface of the photosensitive member 11 to develop the electrostatic latent image. Further, the developing device 2 includes a supply roller (supply striping roller) 32 serving as a developer supply member (developer supply striping member) that supplies the toner to the developing roller 31 and strips the toner from the developing roller 31. The supply roller 32 rotates in a direction indicated by an arrow A3.

Further, the developing device 2 includes a developing blade 33 serving as a regulating member that regulates the toner supplied onto the developing roller 31 to a predetermined toner amount. Further, the developing device 2 includes the developing container 36 that forms a toner accommodating unit (toner container) 37. A one-component toner serving as a developer is accommodated in the toner accommodating unit 37.

### EXAMPLES

The present disclosure will be described in more detail below. However, the present disclosure is not limited thereto. Hereinafter, toners and methods of producing the toners will be described. In examples and comparative examples, “parts” are on a mass basis unless otherwise specified.

### Production Example of Ester Wax A-1

A reaction container provided with a thermometer, a nitrogen introduction pipe, a stirrer, a Deanstarktrap, and a Dimroth condenser was charged with 10 parts of pentaerythritol, 62.5 parts of behenic acid, 10.0 parts of arachidic acid, 26.0 parts of stearic acid, and 1.50 parts of palmitic acid (1.05 molar equivalents of pentaerythritol in total monocarboxylic acid), the reaction was carried out at 220° C. in a nitrogen stream under normal pressure for 20 hours while water generated by the reaction was distilled off, thereby obtaining a crude esterified product. 10 parts of toluene and 5 parts of isopropanol were added to this crude esterified product, 15 parts of a 10% potassium hydroxide aqueous solution in an amount equivalent to 1.5 times the acid value of the crude esterified product was added thereto, and the mixture was stirred at 70° C. for 30 minutes. The mixture was allowed to stand for 30 minutes, and an aqueous phase portion was removed to terminate the deacidification step.

Next, 20 parts of ion exchange water was added to the obtained oil phase portion, and the mixture was stirred at 70° C. for 30 minutes and allowed to stand for 30 minutes to remove the aqueous phase portion. The mixture was washed with water four times until the pH of the removed aqueous phase portion became neutral. After the washing with water, the oil phase portion was decompressed under the conditions of 180° C. and 1 kPa to distill off the solvent, and the resultant was filtered, thereby obtaining an ester wax A-1 (melting point of 75.5° C.) as the final product.

### Production Examples of Ester Waxes A-2 to A-23

Ester waxes A-2 to A-23 were produced in the same manner as in the production example of the ester wax A-1 except for the amounts of behenic acid, arachidic acid, stearic acid, and palmitic acid used in units of parts by mass were changed as listed in Table 1.

### Production Example of Ester Wax A-24

62.5 parts of pentaerythritol tetrabehenate, 10.0 parts of pentaerythritol tetraarachilate, 26.0 parts of pentaerythritol tetrastearate, and 1.50 parts of pentaerythritol tetrapalmitate were mixed with each other, thereby producing an ester wax A-24 (melting point of 75.5° C.).

TABLE 1

| | Behenic acid | Arachidic acid | Stearic acid | Palmitic acid | Melting point |
|---|---|---|---|---|---|
| | (parts) | (parts) | (parts) | (parts) | (° C.) |
| Ester wax A-1 | 62.5 | 10.0 | 26.0 | 1.50 | 75.5 |
| Ester wax A-2 | 68.5 | 10.0 | 20.0 | 1.50 | 76.0 |
| Ester wax A-3 | 58.5 | 10.0 | 30.0 | 1.50 | 75.2 |
| Ester wax A-4 | 65.5 | 7.00 | 26.0 | 1.50 | 75.6 |
| Ester wax A-5 | 65.0 | 7.50 | 26.0 | 1.50 | 75.6 |
| Ester wax A-6 | 61.5 | 15.0 | 22.0 | 1.50 | 75.7 |
| Ester wax A-7 | 60.0 | 10.0 | 28.5 | 1.50 | 75.3 |
| Ester wax A-8 | 70.0 | 8.00 | 20.5 | 1.50 | 76.0 |
| Ester wax A-9 | 71.0 | 8.00 | 19.5 | 1.50 | 76.1 |
| Ester wax A-10 | 73.5 | 10.00 | 15.0 | 1.50 | 76.4 |
| Ester wax A-11 | 71.0 | 5.00 | 22.5 | 1.50 | 75.9 |
| Ester wax A-12 | 50.0 | 15.0 | 30.0 | 5.00 | 74.7 |
| Ester wax A-13 | 80.0 | 5.00 | 15.0 | 0.00 | 76.7 |
| Ester wax A-14 | 63.0 | 10.5 | 26.5 | 0.00 | 75.6 |
| Ester wax A-15 | 63.4 | 10.1 | 26.4 | 0.05 | 75.6 |
| Ester wax A-16 | 63.4 | 10.1 | 26.4 | 0.10 | 75.6 |
| Ester wax A-17 | 60.3 | 9.64 | 25.1 | 5.00 | 75.3 |
| Ester wax A-18 | 60.0 | 10.0 | 20.0 | 10.00 | 75.2 |
| Ester wax A-19 | 63.0 | 10.5 | 26.5 | 0.00 | 75.6 |
| Ester wax A-20 | 100.0 | 0.00 | 0.00 | 0.00 | 82.0 |
| Ester wax A-21 | 0.00 | 100.0 | 0.00 | 0.00 | 80.0 |
| Ester wax A-22 | 0.00 | 0.00 | 100.0 | 0.00 | 78.0 |
| Ester wax A-23 | 45.0 | 20.0 | 35.0 | 0.00 | 75.6 |

### Toner 1

### Step 1: Granulation Step

Styrene: 70 parts
n-butyl acrylate: 30 parts
Carbon black (trade name: #25B, Mitsubishi Chemical Corporation): 7 parts
Divinylbenzene: 0.6 parts
t-dodecyl mercaptan: 1.2 parts
Polymethacrylic acid ester macromonomer (trade name: AA6, manufactured by Toagosei Co., Ltd., Tg=94° C.): 0.3 parts

The above-described materials were mixed and wet-pulverized using a media type wet pulverizer.
Charge control resin (trade name: Acrybase FCA-207P, manufactured by Fujikura Kasei Co., Ltd., styrene/acrylic resin): 1 part
Ester wax A-1 (melting point of 75.5° C.): 15 parts
Olefin unit-containing polystyrene resin B-1 (trade name: HYBRAR 5125, manufactured by KURARAY CO., LTD., including structure represented by formula (1) as olefin unit C): 5 parts

Thereafter, the above-described materials were added and mixed with each other to obtain a polymerizable monomer composition.

An aqueous solution obtained by dissolving 4.1 parts of sodium hydroxide (alkali metal hydroxide) in 50 parts of ion exchange water was gradually added to an aqueous solution obtained by dissolving 7.4 parts of magnesium chloride (water-soluble polyvalent metal salt) in 250 parts of ion exchange water in a stirring tank at room temperature while the mixture was stirred, to prepare a magnesium hydroxide colloidal (sparingly water-soluble metal hydroxide colloidal) dispersion liquid.

Further, 2 parts of methyl methacrylate (Tg=105° C.) as a polymerizable monomer for a shell and 65 parts of ion exchange water were subjected to a fine dispersion treatment using an ultrasonic emulsifier to obtain an aqueous dispersion liquid of a polymerizable monomer for a shell. Further, the particle diameter D90 of liquid droplets of the polymerizable monomer for a shell was 1.6 μm.

The above-described polymerizable monomer composition was added to the magnesium hydroxide colloidal dispersion liquid obtained above, the mixture was stirred until the liquid droplets were stabilized, 6 parts of t-butyl peroxy isobutyrate (trade name: PERBUTYL IB, manufactured by NOF CORPORATION) was added thereto as a polymerization initiator, the mixture was stirred with a high shearing force at a rotation speed of 15000 rpm using an in-line type emulsifying disperser (trade name: MILDER, manufactured by Pacific Machinery & Engineering Co., Ltd.) and dispersed while being circulated, to form liquid droplets of the polymerizable monomer composition.

### Step 2: Polymerization Step

Next, 1 part of a sodium tetraborate decahydrate was added to the aqueous dispersion liquid of the polymerizable monomer composition in which liquid droplets had been formed, the mixture was placed in a reactor equipped with a stirring blade and heated to 85° C. to carry out a polymerization reaction, and the aqueous dispersion liquid of the polymerizable monomer for a shell and 0.3 parts of 2,2′-azobis(2-methyl-N-(2-hydroxyethyl)-propionamide) (trade name: VA-086, manufactured by FUJIFILM Wako Pure Chemical Corporation, water-soluble) as a polymerization initiator for a shell were added to the reactor after the polymerization conversion rate reached about 100%. Further, the polymerization was continuously performed for 4 hours to obtain a resin particle dispersion liquid. Next, the resin particles were formed by excluding carbon black, the charge control resin, the olefin unit-containing polystyrene resin B-1, and the ester wax A-1 used in the above-described step, and the glass transition temperature of the obtained resin particles was measured. The glass transition temperature thereof was 53° C.

### Step 3: Volatile Matter Removal Step

After the resin particle dispersion liquid was heated to 100° C. while being stirred, and held for 2 hours, a volatile matter removal step was performed.

### Post Steps: Filtration, Washing, and Drying Steps

The toner particle dispersion liquid was washed with dilute sulfuric acid (25° C. for 10 minutes) to adjust the pH thereof to 4.5 or less. Next, the dispersion liquid was filtered to separate water, 200 parts of ion exchange water was newly added to the dispersion liquid to form a slurry again, the slurry was repeatedly subjected to a water washing treatment (washing, filtration, and dehydration) several times at room temperature (25° C.), and the obtained solid content was filtered, separated, and dried in a vacuum, thereby obtaining toner particles 1.

1 part of silica fine particles (number average primary particle diameter of 7 nm) subjected to a hydrophobic treatment and 1 part of silica fine particles (number average primary particle diameter of 35 nm) subjected to a hydrophobic treatment were added as external additives to 100 parts of the toner particles 1 obtained above, and the mixture was mixed and stirred using a high-speed stirrer (trade name: Henschel Mixer, manufactured by Mitsui Mining Co., Ltd.) and subjected to an external addition treatment, thereby obtaining a toner 1. The physical properties (the average circularity and the weight-average particle diameter) of the toner 1 are listed in Table 4.

### Toners 2 to 17 and 20 to 30

Toners 2 to 17 and 20 to 30 were obtained in the same manner as in the production example of the toner 1 except that the raw materials including the ester waxes A listed in Table 1 and the olefin unit-containing polystyrene resins B listed in Table 2 and the production conditions were changed as listed in Table 3. The physical properties of these toners are listed in Table 4.

### Toner 18

A pulverized toner was produced by the following method.
Binder resin styrene-n-butyl acrylate copolymer: 100 parts (styrene-n-butyl acrylate copolymer ratio=70:30, Mp=22000, Mw=35000, Mw/Mn=2.4, Tg=55° C.)
Carbon black (trade name: #25B, Mitsubishi Chemical Corporation): 7 parts
Charge control resin (trade name: Acrybase FCA-207P, manufactured by Fujikura Kasei Co., Ltd., styrene/acrylic resin): 1 part
Ester wax A-1:15 parts
Olefin unit-containing polystyrene resin B-1:5 parts

The above-described materials were premixed with a Mitsui Henschel mixer, and melt-kneaded using a twin-screw kneader (PCM-30 type, manufactured by Ikegai Corp.) to obtain a kneaded material. The obtained kneaded material was cooled, coarsely pulverized with a hammer mill (manufactured by Hosokawa Micron Corporation), and pulverized with a mechanical pulverizer (T-250, manufactured by FREUND-TURBO CORPORATION), thereby obtaining finely pulverized powder. The obtained finely pulverized powder was classified with a multi-division classifier (EJ-L-3 type, manufactured BY Nittetsu mining Co., Ltd.) using the Coanda effect, thereby obtaining toner particles. Further, a toner 18 was obtained by adding an external additive to the obtained toner particles in the same manner as in the production example of the toner 1. The physical properties of the toner 18 are listed in Table 4.

### Toner 19

A toner 19 was obtained in the same manner as in the production example of the toner 18 except that the classification step was omitted. The physical properties of the toner 19 are listed in Table 4.

TABLE 2
Olefin unit Polymerization

| | | Olefin unit | Polymerization |
|---|---|---|---|
| | Product name | C | form |
| Olefin unit-containing | HYBRAR 5125 (manufactured by KURARAY CO., | structural | Block |
| polystyrene resin B-1 | LTD.) | formula (1) | |
| Olefin unit-containing | HYBRAR 7125F (manufactured by KURARAY CO., | structural | Block |
| polystyrene resin B-2 | LTD.) | formula (2) | |
| Olefin unit-containing | Septon 2002 (manufactured by KURARAY CO., | structural | Block |
| polystyrene resin B-3 | LTD.) | formula (3) | |
| Olefin unit-containing | STYRENE/ISOPRENE COPOLYMER | structural | Random |
| polystyrene resin B-4 | (manufactured by Sigma-Aldrich) | formula (1) | |
| Polystyrene resin B-5 | Polystyrene (manufactured by FUJIFILM Wako Pure | — | — |
| | Chemical Corporation) | | |

TABLE 3

| Toner | Ester wax | Olefin unit-containing polystyrene resin |
|---|---|---|
| Toner 1 | Ester wax A-1 | Olefin unit-containing polystyrene resin |
| | | B-1 |
| Toner 2 | Ester wax A-24 | Olefin unit-containing polystyrene resin |
| | | B-1 |
| Toner 3 | Ester wax A-2 | Olefin unit-containing polystyrene resin |
| | | B-1 |
| Toner 4 | Ester wax A-3 | Olefin unit-containing polystyrene resin |
| | | B-1 |
| Toner 5 | Ester wax A-4 | Olefin unit-containing polystyrene resin |
| | | B-1 |
| Toner 6 | Ester wax A-5 | Olefin unit-containing polystyrene resin |
| | | B-1 |
| Toner 7 | Ester wax A-6 | Olefin unit-containing polystyrene resin |
| | | B-1 |
| Toner 8 | Ester wax A-7 | Olefin unit-containing polystyrene resin |
| | | B-1 |
| Toner 9 | Ester wax A-8 | Olefin unit-containing polystyrene resin |
| | | B-1 |
| Toner 10 | Ester wax A-9 | Olefin unit-containing polystyrene resin |
| | | B-1 |
| Toner 11 | Ester wax A-10 | Olefin unit-containing polystyrene resin |
| | | B-1 |
| Toner 12 | Ester wax A-11 | Olefin unit-containing polystyrene resin |
| | | B-1 |
| Toner 13 | Ester wax A-12 | Olefin unit-containing polystyrene resin |
| | | B-1 |
| Toner 14 | Ester wax A-13 | Olefin unit-containing polystyrene resin |
| | | B-1 |
| Toner 15 | Ester wax A-1 | Olefin unit-containing polystyrene resin |
| | | B-2 |
| Toner 16 | Ester wax A-1 | Olefin unit-containing polystyrene resin |
| | | B-3 |
| Toner 17 | Ester wax A-1 | Olefin unit-containing polystyrene resin |
| | | B-4 |
| Toner 18 | Ester wax A-1 | Olefin unit-containing polystyrene resin |
| | | B-1 |
| Toner 19 | Ester wax A-1 | Olefin unit-containing polystyrene resin |
| | | B-1 |
| Toner 20 | Ester wax A-14 | Olefin unit-containing polystyrene resin |
| | | B-1 |
| Toner 21 | Ester wax A-15 | Olefin unit-containing polystyrene resin |
| | | B-1 |
| Toner 22 | Ester wax A-16 | Olefin unit-containing polystyrene resin |
| | | B-1 |
| Toner 23 | Ester wax A-17 | Olefin unit-containing polystyrene resin |
| | | B-1 |
| Toner 24 | Ester wax A-18 | Olefin unit-containing polystyrene resin |
| | | B-1 |
| Toner 25 | Ester wax A-19 | None |
| Toner 26 | Ester wax A-20 | Olefin unit-containing polystyrene resin |
| | | B-1 |
| Toner 27 | Ester wax A-21 | Olefin unit-containing polystyrene resin |
| | | B-1 |
| Toner 28 | Ester wax A-22 | Olefin unit-containing polystyrene resin |
| | | B-1 |
| Toner 29 | Ester wax A-23 | Olefin unit-containing polystyrene resin |
| | | B-1 |
| Toner 30 | Ester wax A-1 | Polystyrene resin B-5 |

### Examples 1 to 24 and Comparative Examples 1 to 6

The items listed in Table 4 were evaluated using the above-described toners 1 to 30. The evaluation results thereof are listed in Table 4.

Hereinafter, the evaluation methods and the evaluation criteria of the present disclosure will be described.

A modified laser printer (trade name: LBP-9650Ci, manufactured by Canon Inc.) with a process speed of 250 mm/sec to 350 mm/sec and a fixing temperature of 120° C. to 180° C. was used as the image forming apparatus, and a process cartridge (trade name: Toner Cartridge 323, manufactured by Canon Inc.) was also used.

The product toner was taken out from the inside of the black cartridge, and the cartridge was cleaned with an air blower and filled with 250 g of the toner according to the present disclosure. Further, yellow, magenta, and cyan cartridges were inserted into each of the yellow, magenta, and cyan stations after the product toners were taken out and the remaining toner quantity detection mechanism was disabled, and the evaluations were performed.

### Blocking Resistance

5 g of the toner was weighed with a polyethylene disposable cup, and stored in an environment of 55° C. and 10% RH for 10 days. Next, the blocking resistance was evaluated based on the aggregation state of the toner according to the following evaluation criteria.
A: No change was observed.
B: A small amount of cohesion clusters were found, but quickly disintegrated.
C: A few cohesion clusters were found, and disintegrated with a small impact.
D: Cohesion clusters were found, and were not disintegrated easily.
E: The toner was completely aggregated and solidified in a button shape.

### Evaluation of Hot Offset Resistance

Solid images (toner mounting amount: 0.5 mg/cm²) were formed at a process speed of 260 mm in an environment of normal temperature and normal humidity (25° C./50% RH) while the fixing temperature was increased in 1° C. increments. Plain paper (XEROX 4200 paper in LETTER size, manufactured by Xerox Corporation, 75 g/m²) was used as the transfer material. The occurrence of hot offset was visually confirmed, and the evaluation was performed based on the temperature at which hot offset occurred according to the following criteria.
A: Hot offset occurred at 160° C. or higher.
B: Hot offset occurred at 155° C. or higher and lower than 160° C.
C: Hot offset occurred at 150° C. or higher and lower than 155° C.
D: Hot offset occurred at lower than 150° C.

### Evaluation of Cold Offset Resistance

Solid images (toner mounting amount: 0.9 mg/cm²) were formed at a process speed of 260 mm in an environment of normal temperature and normal humidity (25° C./50% RH) while the fixing temperature was decreased in 1° C. increments. Plain paper (XEROX 4200 paper in LETTER size, manufactured by Xerox Corporation, 75 g/m²) was used as the transfer material. The occurrence of cold offset was visually confirmed, and the evaluation was performed based on the temperature at which hot offset occurred according to the following criteria.
A: The minimum fixing temperature was lower than 130° C.
B: The minimum fixing temperature was 130° C. or higher and lower than 135° C.
C: The minimum fixing temperature was 135° C. or higher and lower than 140° C.
D: The minimum fixing temperature was higher than 140° C.

### Evaluation of Development Stripe

The durability test was performed with a process speed of 350 mm/sec in a high-temperature and high-humidity environment (30° C./80° C. RH). The fixing temperature was adjusted to 150° C. CS-680 (sold by Canon Marketing Japan Inc.) was used as durable paper, and an image of horizontal lines with a printing ratio of 1.5% was used as the durability evaluation chart. 21000 sheets of images were printed out in a sequence with a 4 second pause after every two sheets of printing. Next, a halftone image was printed out on high white paper (trade name: GF-C081, manufactured by Canon Inc., 81.4 g/m²), and the development stripe was evaluated. Further, the cartridge was disassembled, and the number of stripes on the developing roller was counted.

### Evaluation Criteria

A: Development stripes did not occur on the D roll (developing roller).
B: Development stripes occurred on the D roller (developing roller), but did not occur on the halftone image.
C: Multiple development stripes occurred on the D roller (developing roller), but did not occur on the halftone image.
D: Multiple development stripes occurred on the D roller (developing roller), and white stripes were found on the halftone image.

### Evaluation of Mottle in Fixed Image

Rough paper OCE RED LABEL (basis weight: 80 g/m²) was used as the evaluation paper. 100 sheets of solid images with a printing ratio of 100% were continuously printed in a single-sided printing with a process speed of 260 mm/sec in an environment of normal temperature and normal humidity (25° C./50% RH). The fixing temperature was adjusted to 150° C.

The mottle in the obtained image was visually confirmed and determined according to the following index. The mottle is a type of image with fixing failure and denotes that an extremely low melt viscosity of the toner image leads to appearance of fibers in the paper and formation of a rough image, and rough paper with a more uneven paper surface was used as evaluation paper in place of plain paper. The occurrence of mottle was visually confirmed, and the evaluation was performed according to the following criteria. The number of sheets of rough paper in which the mottle had occurred was counted.
A: Mottle did not occur in all 100 sheets of paper.
B: 1 to 3 sheets among 100 sheets of paper had sites where mottle occurred.
C: 4 to 9 sheets among 100 sheets of paper had sites where mottle occurred.
D: 10 or more sheets among 100 sheets of paper had sites where mottle occurred.

TABLE 4

| | | | | | Evaluation of | | Evaluation of | | Evaluation of | | Evaluation | |
|---|---|---|---|---|---|---|---|---|---|---|---|---|
| | | Average | D4 | Blocking | hot offset | | cold offset | | development | | mottle in | |
| | Toner | circularity | (μm) | resistance | resistance | | resistance | | stripe | | fixed image | |
| Example 1 | Toner 1 | 0.995 | 7.5 | A | A | 161 | A | 128 | A | 0 | A | 0 |
| Example 2 | Toner 2 | 0.995 | 7.5 | A | A | 161 | A | 128 | A | 0 | A | 0 |
| Example 3 | Toner 3 | 0.995 | 7.5 | A | A | 165 | B | 133 | A | 0 | A | 0 |
| Example 4 | Toner 4 | 0.995 | 7.5 | A | B | 156 | A | 125 | A | 0 | A | 0 |
| Example 5 | Toner 5 | 0.995 | 7.5 | A | A | 165 | B | 132 | A | 0 | A | 0 |
| Example 6 | Toner 6 | 0.995 | 7.5 | A | A | 165 | B | 130 | A | 0 | A | 0 |
| Example 7 | Toner 7 | 0.995 | 7.5 | A | A | 160 | A | 128 | A | 0 | A | 0 |
| Example 8 | Toner 8 | 0.995 | 7.5 | A | B | 158 | A | 125 | A | 0 | A | 0 |
| Example 9 | Toner 9 | 0.995 | 7.5 | A | A | 166 | C | 135 | A | 0 | A | 0 |
| Example 10 | Toner 10 | 0.995 | 7.5 | A | A | 166 | C | 136 | A | 0 | A | 0 |
| Example 11 | Toner 11 | 0.995 | 7.5 | A | A | 167 | C | 137 | A | 0 | A | 0 |
| Example 12 | Toner 12 | 0.995 | 7.5 | A | A | 166 | C | 137 | A | 0 | A | 0 |
| Example 13 | Toner 13 | 0.995 | 7.5 | A | C | 153 | A | 123 | A | 0 | A | 0 |
| Example 14 | Toner 14 | 0.995 | 7.5 | A | A | 168 | C | 138 | A | 0 | C | 6 |
| Example 15 | Toner 15 | 0.995 | 7.5 | A | A | 161 | A | 128 | B | 1 | A | 0 |
| Example 16 | Toner 16 | 0.995 | 7.5 | B | A | 161 | A | 128 | B | 2 | A | 0 |
| Example 17 | Toner 17 | 0.995 | 7.5 | C | A | 161 | A | 128 | C | 4 | A | 0 |
| Example 18 | Toner 18 | 0.970 | 7.5 | A | A | 161 | A | 128 | B | 3 | A | 0 |
| Example 19 | Toner 19 | 0.950 | 7.5 | A | A | 161 | A | 128 | C | 5 | A | 0 |
| Example 20 | Toner 20 | 0.995 | 7.5 | A | A | 162 | A | 128 | A | 0 | C | 6 |
| Example 21 | Toner 21 | 0.995 | 7.5 | A | A | 163 | A | 128 | A | 0 | B | 3 |
| Example 22 | Toner 22 | 0.995 | 7.5 | A | A | 163 | A | 128 | A | 0 | B | 1 |
| Example 23 | Toner 23 | 0.995 | 7.5 | A | B | 159 | B | 131 | A | 0 | A | 0 |
| Example 24 | Toner 24 | 0.995 | 7.5 | A | B | 158 | B | 133 | A | 0 | A | 0 |
| Comparative | Toner 25 | 0.995 | 7.5 | E | A | 162 | A | 128 | D | 7 | C | 6 |
| Example 1 | | | | | | | | | | | | |
| Comparative | Toner 26 | 0.995 | 7.5 | A | A | 169 | D | 142 | A | 0 | C | 6 |
| Example 2 | | | | | | | | | | | | |
| Comparative | Toner 27 | 0.995 | 7.5 | A | D | 145 | A | 122 | A | 0 | C | 6 |
| Example 3 | | | | | | | | | | | | |
| Comparative | Toner 28 | 0.995 | 7.5 | A | D | 143 | A | 122 | A | 0 | C | 6 |
| Example 4 | | | | | | | | | | | | |
| Comparative | Toner 29 | 0.995 | 7.5 | A | D | 149 | A | 123 | A | 0 | C | 6 |
| Example 5 | | | | | | | | | | | | |
| Comparative | Toner 30 | 0.995 | 7.5 | D | A | 161 | A | 128 | D | 6 | A | 0 |
| Example 6 | | | | | | | | | | | | |

According to the present disclosure, it is possible to provide a toner, a process cartridge, and an image forming apparatus, which are capable of achieving both the durability and a wide fixing temperature range even in a high-temperature environment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-006520, filed Jan. 17, 2025 and No. 2025-245144, filed Dec. 11, 2025, which are hereby incorporated by reference herein in their entirety.

What is claimed is:

1. A toner comprising:
a toner particle that contains a binder resin, an olefin unit-containing polystyrene resin B, and an ester wax A,
wherein the olefin unit-containing polystyrene resin B is a copolymer having an olefin unit and a styrene unit,
the ester wax A is an ester compound having a structure represented by formula (A), 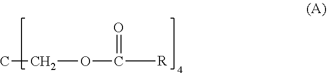
in formula (A), each R independently represents an n-alkyl group,
the ester compound includes, as the n-alkyl group, n-heneicosyl group, n-nonadecyl group, and n-heptadecyl group,
a content proportion of n-heneicosyl group is 50.0% by mass or greater and 80.0% by mass or less with respect to a total mass of groups which is included as the n-alkyl group,
a content proportion of n-nonadecyl group is 5.0% by mass or greater and 15.0% by mass or less with respect to the total mass of groups which is included as the n-alkyl group, and
a content proportion of n-heptadecyl group is 15.0% by mass or greater and 30.0% by mass or less with respect to the total mass of groups which is included as the n-alkyl group.

2. The toner according to claim 1,
wherein the content proportion of n-heneicosyl group is 60.0% by mass or greater and 70.0% by mass or less with respect to the total mass of groups which is included as the n-alkyl group,
the content proportion of n-nonadecyl group is 7.5% by mass or greater and 15.0% by mass or less with respect to the total mass of groups which is included as the n-alkyl group, and
the content proportion of n-heptadecyl group is 20.0% by mass or greater and 30.0% by mass or less with respect to the total mass of groups which is included as the n-alkyl group.

3. The toner according to claim 1,
wherein the olefin unit-containing polystyrene resin B is a block copolymer of a polyolefin segment containing the olefin unit and a polystyrene segment.

4. The toner according to claim 1,
wherein the binder resin is a styrene acrylic copolymer.

5. The toner according to claim 1,
wherein the toner has an average circularity of 0.960 or greater and 0.995 or less.

6. The toner according to claim 1,
wherein the ester compound includes as the n-alkyl group, n-pentadecyl group.

7. The toner according to claim 6,
wherein a content proportion of n-pentadecyl group is 0.1% by mass or greater and 5.0% by mass or less with respect to the total mass of groups which is included as the n-alkyl group.

8. A process cartridge that is detachably attachable to an image forming apparatus, the process cartridge comprising:
a toner; and
a toner container that accommodates the toner,
wherein the toner comprises a toner particle containing a binder resin, an olefin unit-containing polystyrene resin B, and an ester wax A,
wherein the olefin unit-containing polystyrene resin B is a copolymer having an olefin unit and a styrene unit,
the ester wax A is an ester compound having a structure represented by formula (A), 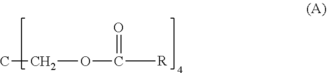
in formula (A), each R independently represents an n-alkyl group,
the ester compound includes, as the n-alkyl group, n-heneicosyl group, n-nonadecyl group, and n-heptadecyl group,
a content proportion of n-heneicosyl group is 50.0% by mass or greater and 80.0% by mass or less with respect to a total mass of groups which is included as the n-alkyl group,
a content proportion of n-nonadecyl group is 5.0% by mass or greater and 15.0% by mass or less with respect to the total mass of groups which is included as the n-alkyl group, and
a content proportion of n-heptadecyl group is 15.0% by mass or greater and 30.0% by mass or less with respect to the total mass of groups which is included as the n-alkyl group.

9. An image forming apparatus comprising:
a toner;
a toner bearing member that bears the toner;
an electrostatic latent image bearing member;
a charging unit configured to cause a charging member to charge a surface of the electrostatic latent image bearing member;
an electrostatic latent image forming unit configured to form an electrostatic latent image on the charged electrostatic latent image bearing member;
a developing unit configured to develop the electrostatic latent image using the toner to form a toner image on the electrostatic latent image bearing member;
a transfer unit configured to transfer the toner image to a recording medium; and
a fixing unit configured to fix the toner image transferred onto the recording medium to the recording medium,
wherein the toner comprises a toner particle containing a binder resin, an olefin unit-containing polystyrene resin B, and an ester wax A,
the olefin unit-containing polystyrene resin B is a copolymer having an olefin unit and a styrene unit,
the ester wax A is an ester compound having a structure represented by formula (A), 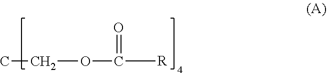
in formula (A), each R independently represents an n-alkyl group,
the ester compound includes, as the n-alkyl group, n-heneicosyl group, n-nonadecyl group, and n-heptadecyl group,
a content proportion of n-heneicosyl group is 50.0% by mass or greater and 80.0% by mass or less with respect to a total mass of groups which is included as the n-alkyl group,
a content proportion of n-nonadecyl group is 5.0% by mass or greater and 15.0% by mass or less with respect to the total mass of groups which is included as the n-alkyl group, and
a content proportion of n-heptadecyl group is 15.0% by mass or greater and 30.0% by mass or less with respect to the total mass of groups which is included as the n-alkyl group.
